(19) United States
(12) Patent Application Publication
(10) Pub. No.: US 2023/0363585 A1
(43) Pub. Date: Nov. 16, 2023

(54) A Frying Apparatus

(71) Applicant: ON2COOK INDIA PVT LTD

(72) Inventor: Sudhir Sanandan, Ahmedabad (IN)

(21) Appl. No.: 18/029,965

(22) PCT Filed: Oct. 26, 2021
(86) PCT No.: PCT/IB2021/059882

§ 371 Date: Apr. 3, 2023

(30) Foreign Application Priority Data
Oct. 26, 2020 (IN) 202021046537

(51) Int. Cl. A47J 37/12

(52) U.S. Cl. CPC A47J 37/1266; A47J 37/1228; A47J 37/1285

(57) ABSTRACT

An improved frying apparatus 100 is disclosed having an oil pan 114 to hold oil for frying the food items that is heated by a conventional heat source, such as gas burner, a hot plate, resistance heater and an induction heating device and at least one microwave generating device 108 as a source of microwaves that in combination with application of heat using the conventional heat source enables direct cooking of interior of the food item as outer layer of the food item is being fried in the hot oil. Simultaneous heating of interior of the food item by microwave results in substantial reduction in frying time, absorption of the oil by the food item and oil wastage.

### TECHNICAL FIELD

The present disclosure relates to the field of cooking apparatuses. In particular, the present disclosure relates to a frying apparatus that enables efficient and faster frying of food items.

### BACKGROUND

Background description includes information that may be useful in understanding the present invention. It is not an admission that any of the information provided herein is prior art or relevant to the presently claimed invention, or that any publication specifically or implicitly referenced is prior art.

Fast food outlets, such as McDonalds®, carry out frying of large numbers of fries and patties. Specifically they are required to fry these food items after receipt of order within a short time to meet their committed delivery time. At times, they are also required to cook large quantities at short notice.

Conventional method for frying the food items in such food outlets employ oil pans to heat the cooking oil, and strainers in which the food item to be fried is placed and dipped into the hot oil. After the frying is complete the strainer is removed to drain the oil and serve the food item. This whole process is done manually, resulting in human intervention for adding food items for frying as well as for straining and dispensing into the serving container.

However, to meet the earlier mentioned requirements the food outlets use large oil pan and keep it warm so that the items may be fried quickly without having to wait for the oil to heat up. The oil that is kept at high temperature for long being carciogenic becomes unfit for further cooking, and has to be discarded. This makes the entire process expensive and inefficient.

In the conventional method of frying food items, the process is time-consuming because the heat gets transferred layer by layer from the outermost layer of the patty or French fries to the central portion. In this process only an optimal amount of heat can be provided to the outer surface of the food item so that it does not get burned before the food item is cooked completely right to the core. This increases the time required to fry the food items. The drawback exists because there is only one source of heating (and that is the hot oil) which transfers heat linearly from the outer surface to the core of the food item.

Besides longer cooking time, the conventional method of frying using a single source of heat also results in the food item absorbing large amount of cooking oil. This is so because as the moisture content of the food item being fried gets evaporated slowly, it is replaced by oil. As it is desirable to minimize quantity of oil absorbed by the food item being absorbed, both from the point of view of health of those consuming the fried food item as well as from the point of view of cost of oil consumption during cooking, it would be desirable to have a frying process and corresponding apparatus that results in reduced absorption of the frying oil during frying of food items.

It would be additionally beneficial if a frying apparatus could be provided that avoids keeping large amount of oil at elevated temperature to meet immediate frying needs, thereby avoiding deterioration in quality of oil.

Therefore, there is a requirement of an improved frying apparatus that overcomes the drawbacks of the conventional frying method.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about. ” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a, ” “an, ” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### OBJECTS OF THE INVENTION

A general object of the present disclosure is to overcome drawbacks of the conventional frying methods.

An object of the present disclosure is to provide a frying apparatus that enables implementation of an improved frying method to overcome drawbacks of the conventional frying methods.

Another object of the present disclosure is to provide a frying apparatus that uses microwaves toenable direct cooking of interior of the food item as outer layer of the food item is being fried in hot oil.

Another object of the present disclosure is to provide a method of cooking using combination of microwave cooking and frying in combination.

Another object of the present disclosure is to provide a frying apparatus that has the ability to automatically load the food items into the frying pan from a frozen chamber.

Another object of the present disclosure is to provide a frying apparatus where the amount of oil can be reduced or increased depending upon the amount of food items to be fried automatically, as well as to avoid keeping the large amount of oil at elevated temperature to meet immediate frying needs.

### SUMMARY

Aspects of the present disclosure relate to an improved frying apparatus that enables efficient frying of food items. In particular, it overcomes drawbacks of the conventional frying methods employed in establishments like fast food outlets.

In an aspect, the proposed frying apparatus for frying food items includes an oil pan to hold oil for frying the food items; a conventional heat source to heat the oil in the oil pan; and at least one microwave generating device as a source of microwaves that in combination with application of heat using the conventional heat source enables direct cooking of interior of the food item as outer layer of the food item is being fried in the hot oil.

The conventional heat source can be any or a combination of a gas burner, a hot plate, resistance heater and an induction heating device.

In an embodiment, the apparatus may include at least one pan, each pan having a loading and serving portion, and a cooking portion. The pan may be pivotally held for movement between a first position and a second position. In the first position of the pan the food items may be loaded onto the loading and serving portion, and as the pan is moved to the second position the food items slide to the cooking portion of the pan where the food items get dipped in hot oil for frying. When the pan is moved back to the first position from the second position, the food items slide back to the loading and serving portion for serving.

The apparatus may include a storage station for storing a plurality of frozen food chambers. There can be one storage station for each pan. Each frozen food chamber may include a knob on the chamber to dispense the frozen food items into the pan, automatically or manually.

The apparatus may include a lid that is pivotally movable to cover the cooking portion in the second position of the pan.

The cooking portion may include a strainer to drain the oil as the pan is moved from the second position to the first position.

The apparatus may include a housing, and a lower portion of the housing may be configured to function as an oil pan to hold the oil, and the at least one microwave generating device may be fixed to an upper portion of the housing.

The pan may be pivotally configured with the housing such that in the second position of the pan the loading and serving portion of the pan closes an opening of the housing and the cooking portion of the pan dips into the oil held in the oil pan.

In an alternate embodiment, the cooking portion of the pan may be configured to function as an oil pan to hold the oil and shaped such that the oil is retained within the cooking portion when the pan is moved between the first position and the second position, and the at least one microwave generating device may be fixed to the pan to cover the cooking portion.

The at least one microwave generating device may be fixed, and the pan, when moved to the second position, gets coupled with the at least one microwave generating device.

In an embodiment, the apparatus may include an oil transfer mechanism having an oil storage tank and an oil transfer pump. The oil transfer mechanism may be configured to transfer oil between the oil pan and the oil storage tank based on quantity of the food items to be fried.

The oil transfer mechanism may be configured to, when there is no requirement of frying, transfer the oil from the oil pan to the oil storage tank to minimize the oil quantity in the oil pan that is kept in hot condition to meet frying requirement within a stipulated time frame on receipt of order.

An aspect of the present disclosure relates to a method for cooking a food item. The method may include the steps of: cooking an outer layer of the food item by frying in hot oil by dipping the food item in an oil pan having the hot oil; and cooking an inner portion of the food item by microwave cooking using at least one microwave generating device.

In the proposed method, the food item may be placed on a pan that is configured to move between a first position and a second position, and the frying takes place in the second position of the pan and the microwave cooking takes place in the second position of the pan.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates an exemplary image of the disclosed frying apparatus in accordance with the first embodiment of the present disclosure.

FIGS. 2A and 2B illustrate exemplary perspective views of the disclosed frying apparatus in accordance with the first embodiment, showing the pan in a first position and the second position respectively.

FIGS. 3A and 3B illustrate exemplary side views of the disclosed frying apparatus in accordance with the first embodiment, showing the pan in a first position and the second position respectively.

FIG. 4 illustrates an exemplary perspective views of the disclosed frying apparatus in accordance with the second embodiment.

FIGS. 5A and 5B illustrate exemplary side views of the disclosed frying apparatus in accordance with the second embodiment, showing the pan in a first position and the second position respectively.

FIG. 6 illustrates an exemplary image of the disclosed frying apparatus in accordance with the third embodiment of the present disclosure.

FIG. 7A and 7B illustrate exemplary perspective view and side view of the disclosed frying apparatus in accordance with the third embodiment.

FIG. 8 illustrates an exemplary flow diagram for the method of frying a food item, in accordance with an embodiment of the present disclosure.

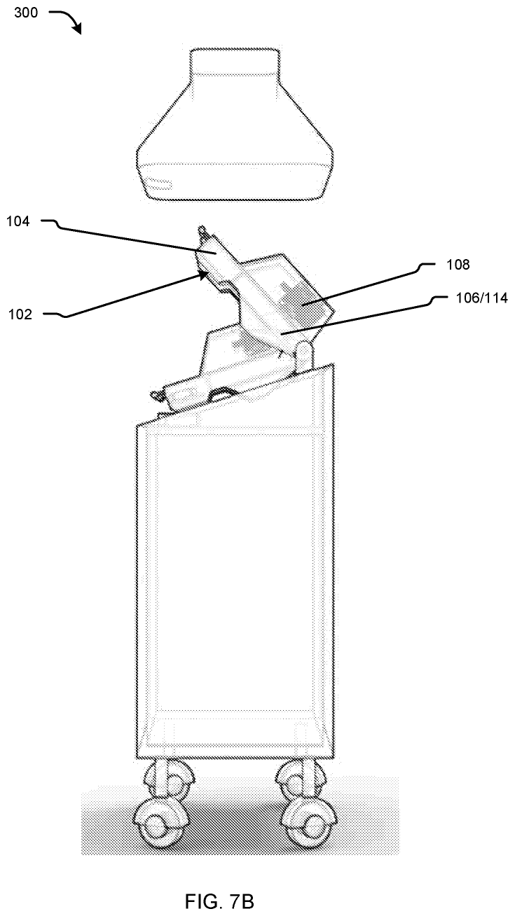

FIG. 9 illustrates an exemplary perspective view of the disclosed frying apparatus showing oil pump and oil storage tanks for storing fresh oil and partially used oil, in accordance with an embodiment of the present disclosure.

FIG. 10 illustrates an exemplary frow diagram showing working of a mobile App and a controller of the frying apparatus for executing different functions of the apparatus, in accordance with an embodiment of the present disclosure.

FIGS. 11A to 11C illustrate exemplary frow diagrams showing flow of oil between different tanks and the oil pan during down time, low volume cooking and peak/high volume cooking respectively, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

Various terms are used herein. To the extent a term used in a claim is not defined, it should be given the broadest definition persons in the pertinent art have given that term as reflected in printed publications and issued patents at the time of filing.

Embodiments explained herein relate to a frying apparatus that includes at least one microwave generating device as a source of microwaves that in combination with application of heat using a conventional heat source enables direct cooking of interior of the food item being fried as outer layer of the food item is being fried in the hot oil. In an aspect, direct heating of interior of the item being fried as the outer layer of the food item is being fried in the hot oil, results in substantial reduction in frying time, reduced oil absorption by the food item making the food item healthier and cheaper on account of reduced oil consumption during the frying process.

In an aspect, heating inside of the items being fried by the microwaves results in fast evaporation of the moisture present in inner part of the food item, and the resultant steam tends to escape outwards under pressure. The steam escaping under pressure prevents inwards penetration of oil, thereby reducing oil content in the fried item and reduced oil consumption in the frying process. Besides, the simultaneous heating of the interior of the cooking item by the microwaves, while the outer portion is being cooked by hot oil, results in substantial reduction in frying time.

It is found that the proposed apparatus can result in reduction of the frying time to one third and the oil consumption is reduced by half.

In an aspect, the disclosed frying apparatus can also include a mechanism to transfer a part of oil from the oil pan of the apparatus to a storage tank when no frying is being done. The transfer of at least a portion of oil can be done when no frying is being done. The portion of oil retained in the oil pan can be kept at a desired temperature for frying to meet the requirement of frying within a stipulated time frame on receipt of order. If the amount of oil retained in the oil pan is not sufficient to meet the frying requirement, the oil transfer mechanism can transfer the oil back from the storage tank to the oil pan. The arrangement reduces oil heating time as the retained oil is at the desired temperature, and the quantity of oil at the elevated temperature being reduced, deterioration in the oil quality due to high temperature is reduced. Therefore, wastage of oil is reduced. It is found that coupled with the reduced oil absorption by the food items, the oil transfer mechanism can result in an overall reduction in oil wastage and consumption by up to 70%.

In another aspect, the oil retained in the oil pan can be optimized based on artificial intelligence to predict order size that may be received given time of the day, day of the week and time of the year.

In an aspect, the frying apparatus can be coupled to an App that is configured to make the apparatus fully automated based on received orders. It can operate the frying apparatus to heat oil based on the required quantity of the food item to be fried, select, based on the received order, the items to be fried, enable transfer of the selected items from a storage station to the frying apparatus, control duration of frying based on the item being fried and remove the fried items from the oil pan after the frying duration for serving.

In an aspect, the App can also manage inventory of the food items in the storage station and order the items when the stock falls below a critical level arrived based on estimated requirement. In another aspect, artificial intelligence can be used to estimate the off take of the food items for different times of the day, different days of the month and different times of the year considering holidays etc.

In an aspect, the proposed frying apparatus can include a pivotally held pan having a loading a serving portion and a cooking portion, and movable between a first position in which the food item for cooking is loaded on the loading a serving portion, and a second position in which the food item slides from the loading a serving portion to the cooking portion and gets dipped in hot oil. In the first position of the pan the food items are loaded onto the loading and serving portion, and as the pan is moved to the second position the food items slide to the cooking portion of the pan where the food items get dipped in hot oil for frying, and wherein when the pan is moved back to the first position from the second position, the food items slide back to the loading and serving portion for serving.

The apparatus may include a housing and a lower portion of the housing may be configured to function as an oil pan to hold the oil. At least one microwave generating device may be fixed to an upper portion of the housing.

The pan may be pivotally configured with the housing such that in the second position of the pan the loading and serving portion of the pan closes an opening of the housing and the cooking portion of the pan dips into the oil held in the oil pan.

In an alternate embodiment, the cooking portion of the pan may be configured to function as an oil pan to hold the oil and shaped such that the oil is retained within the cooking portion when the pan is moved between the first position and the second position. The microwave generating device may be fixed to the pan to cover the cooking portion.

In another embodiment, the microwave generating device may be fixed, and the pan, when moved to the second position, nay get coupled with the at least one microwave generating device.

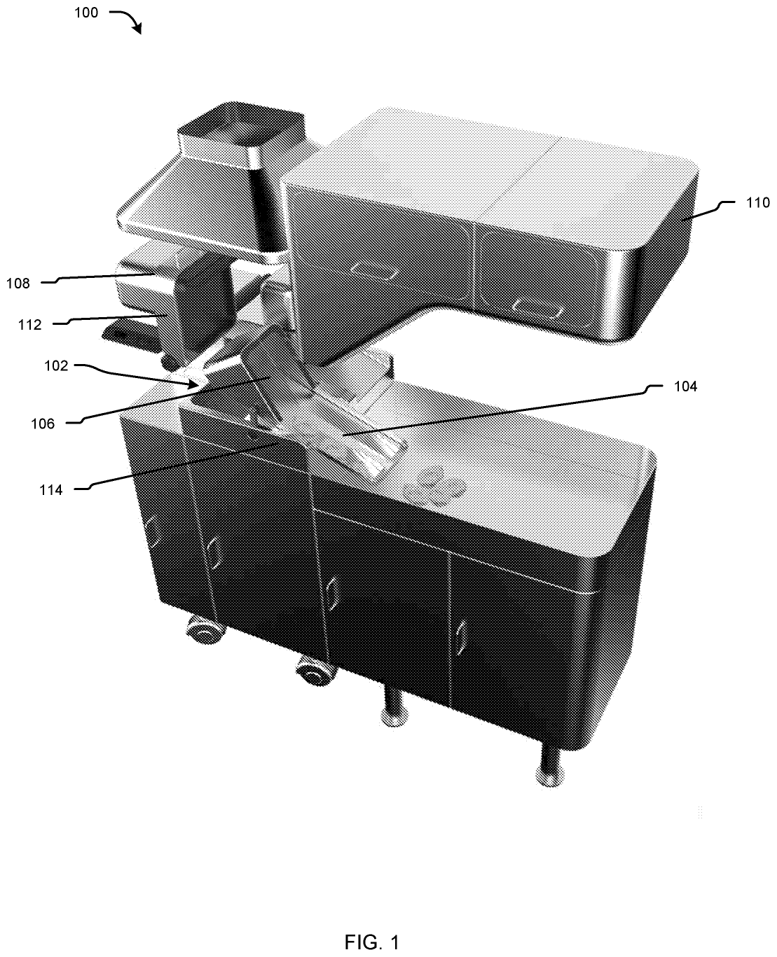

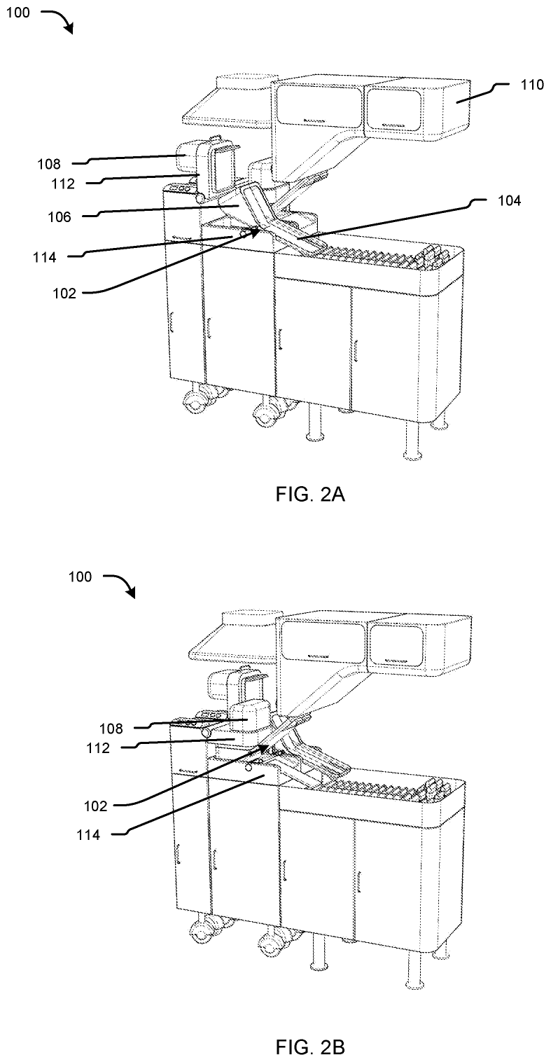

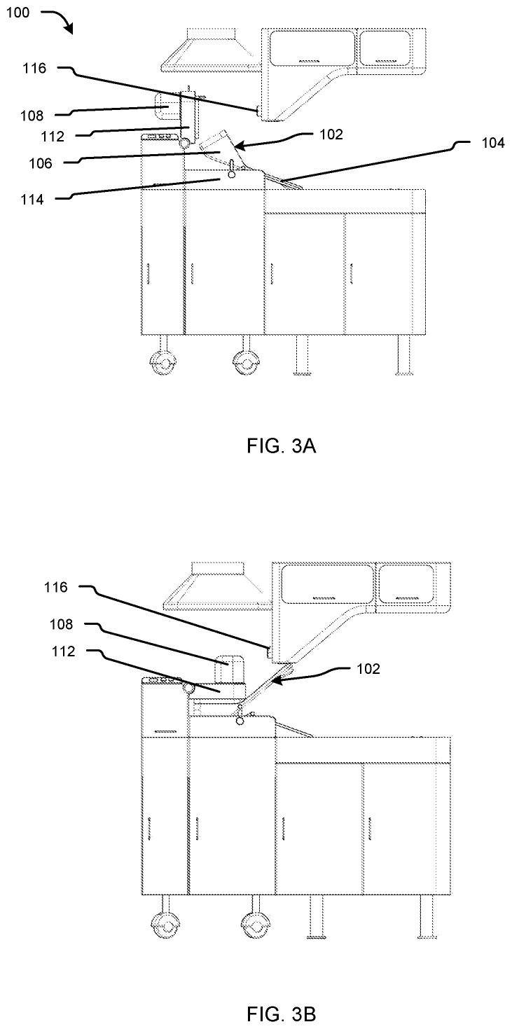

Referring now to FIGS. 1 to 3B, where a first embodiment of the disclosed frying apparatus is disclosed, the frying apparatus can 100 include a pan 102 that is pivotally held. The pan 102 includes a loading and serving portion 104, and a cooking portion 106. The pivotal arrangement of the pan 102 can allow the pan 102 to move between a first position, shown in FIGS. 2A and 3A, and a second position, shown in FIGS. 2B and 3B.

The apparatus 100 can also include a storage station 110, shown in FIGS. 1A-2C. As shown in FIGS. 2B and 3B, in the second position of the pan 102, the loading and the serving portion 104 can link up with the storage station 110 such that the food item released from the storage station 110 drops on the loading and the serving portion 104 and slides down to the cooking portion 106, which is dipped in the hot oil, for frying. When the pan 102 is moved to the first position, cooking portion 106 comes out of the oil along with the food items, and the food items can slide to the loading and the serving portion 104.

In an embodiment, the storage station 110 can have a plurality of frozen food chambers, one for each pan 102, and each frozen food chamber can include a knob 116, shown in FIGS. 3A and 3B, on the frozen food chambers to dispense the frozen food items into the pan 102 automatically or manually. The knobs 116 can have positions to dispense varying quantities of the stored food item. The automatic dispensing eliminates the need of a human trying to add frozen food items every minute into the cooking chamber.

In an aspect, the proposed apparatus can include an oil pan 114 can be heated from below by a heat source such as but not limited to, a gas burner, hot plate, induction heating etc.

The oil pan 114 has a mechanism for automatically increasing or decreasing the amount of oil depending upon the quantity of the food items to be fried. The mechanism can include an oil storage tank and an oil transfer pump to transfer the oil from the oil pan 114 to the oil storage tank and vice versa. The mechanism can work to transfer the oil from the oil pan to the oil storage tank when the there is no frying requirement to minimize the quantity of oil to be kept hot to meet frying and meet order delivery time commitment. The portion of oil retained in the oil pan can be kept at a desired temperature to meet the requirement of immediate frying when a demand arises. If the amount of oil retained in the oil pan is not sufficient to meet the frying requirement, the oil transfer mechanism can transfer the oil back from the storage tank to the oil pan. The arrangement reduces oil heating time as the retained oil is at the desired temperature, and the quantity of oil at the elevated temperature being reduced, deterioration in the oil quality due to high temperature is reduced.

In an aspect, when the pan 102 is moved back to the first position from the second position, the cooking portion 106 can come out of the hot oil, and the food items can slide back to the loading and serving portion 104 from where they can be picked for serving. The cooking portion 106 of the pan 102 includes strainer to drain the oil as the pan is moved from the second position to the first position.

The apparatus 100 can further include at least one microwave generating device 108 fixed with the lid 112 for movement along with the lid 112. When the lid 112 is closed over the cooking portion 106 of the lid 102 or the oil pan 114, the microwave generating device 108 may be used to heat the oil. The microwave generating device 108 may also be used for microwave cooking of the food item after frying in the oil. As would be appreciated, FIG. 3A shows the microwave generating device 108 in closed (in use) position and FIG. 3B shows the microwave generating device 108 in open (not in use) position.

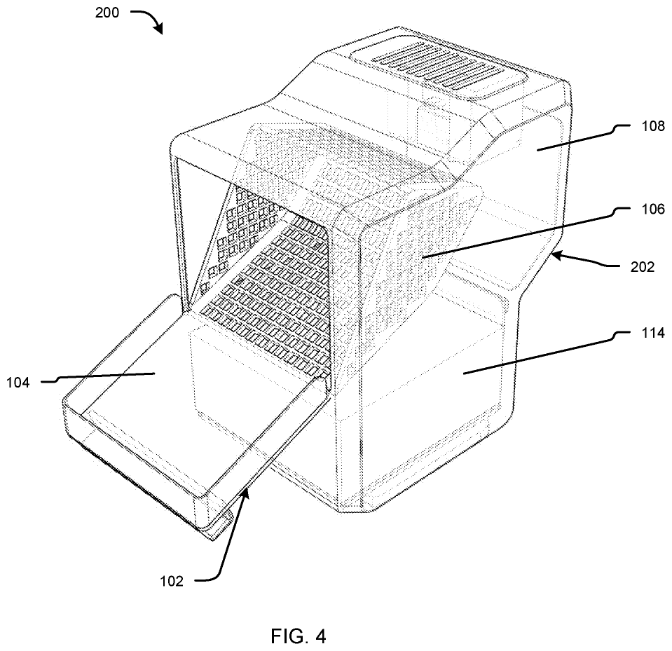

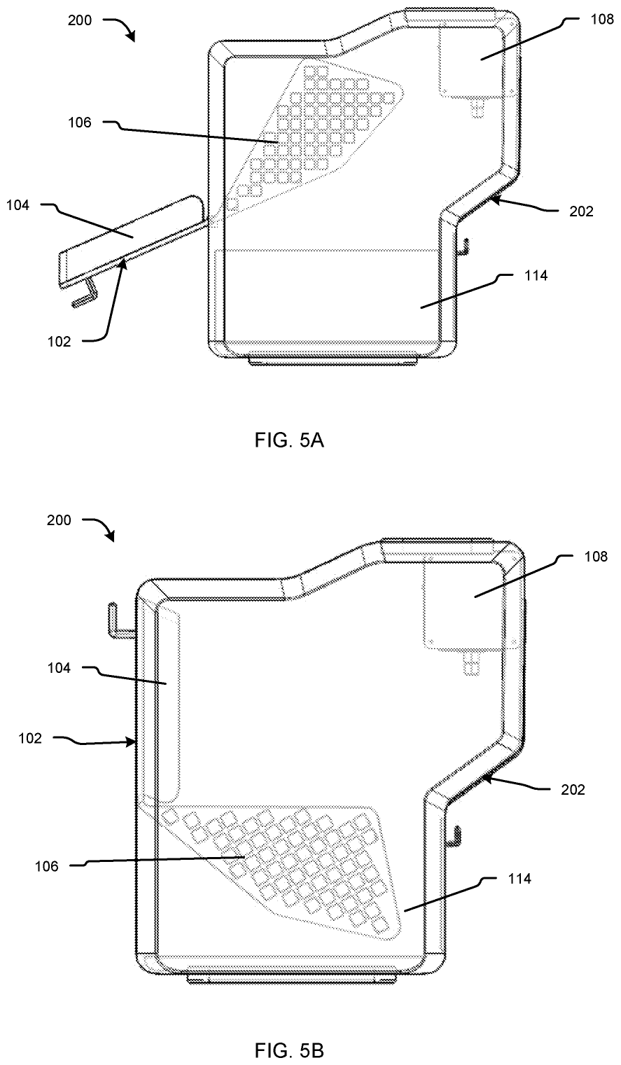

Referring to FIGS. 4 to 5B, where a second embodiment of the apparatus, identified as frying apparatus 200 is disclosed, the apparatus 200 can include a housing 202, with a lower portion of the housing configured to function as an oil pan 114 to hold the oil for frying. At least one microwave generating device 108 can be fixed to an upper portion of the housing 202. The pan 102 can be pivotally configured with the housing 202 such that in the second position of the pan 102, the loading and serving portion 104 of the pan 102 closes an opening of the housing 202, as shown in FIG. 5B, and the cooking portion 106 of the pan 102 dips into the oil held in the oil pan 114. The cooking portion 106 of the pan 102 can include strainer to drain the oil as the pan 102 is moved from the second position (in which the serving portion is closed) to the first position (in which the serving portion is open), shown in FIG. 5A.

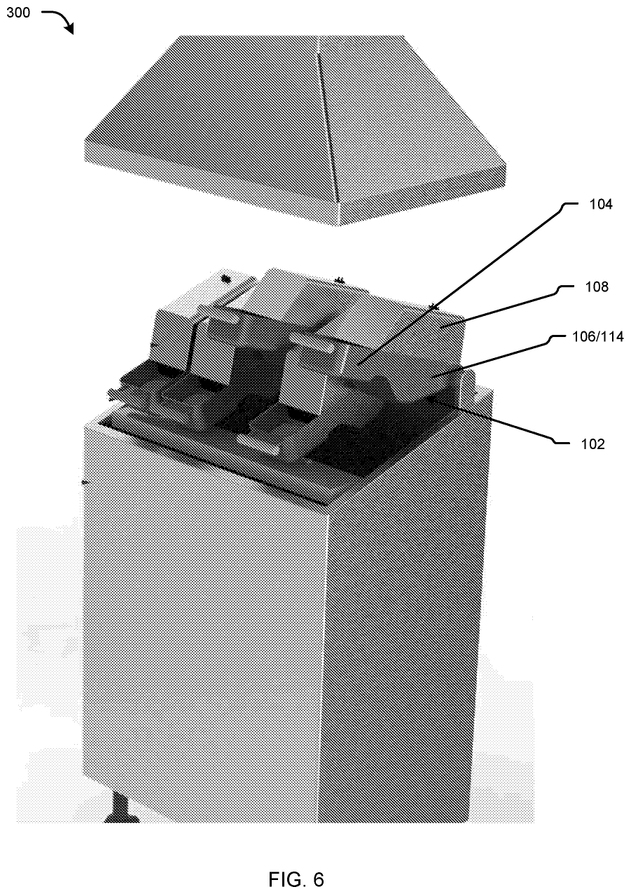

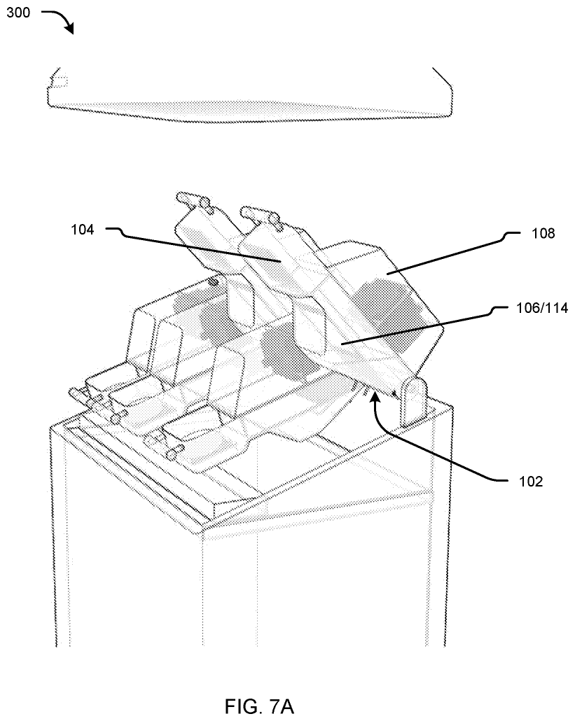

Referring to FIGS. 6 to 7B, where a third embodiment of the frying apparatus identified as apparatus 300, is disclosed, the cooking portion 106 of the pan 102 is configured to function as an oil pan 114 to hold the oil and shaped such that the oil is retained within the cooking portion when the pan 102 is moved between the first position and the second position. The at least one microwave generating device 108 may be fixed to the pan 102 to cover the cooking portion 106 of the pan 102.

In an alternate arrangement of the third embodiment, the at least one microwave generating device 108 may be fixed, and the pan 102, when moved to the second position, gets coupled with the at least one microwave generating device 108.

An aspect of the present disclosure, a method for cooking a food item is disclosed. The method includes the steps of: cooking an outer layer of the food item by frying in hot oil by dipping the food item in an oil pan, such as oil pan 114, having the hot oil; and cooking an inner portion of the food item by microwave cooking using at least one microwave generating device, such a microwave generating device 108 shown in FIGS. 1 to 3B. The food item may be placed on a pan, such as pan 102 shown in FIGS. 1 to 3B, that is configured to move between a first position and a second position, and the frying can take place in the first position of the pan and the microwave cooking can take place in the second position of the pan 102.

An aspect of the present disclosure also relates to a method for frying food items, the method 800 can include the step 802 of cooking an outer layer of the food item by frying in hot oil by dipping the food item in an oil pan having the hot oil. The method 800 can further include the step 804 of cooking an inner portion of the food item by microwave cooking using at least one at least one microwave generating device.

The food item may be placed on the pan 102 that is configured to move between a first/open position and a second/closed position, and the frying and the microwave cooking takes place in the second position of the pan 102.

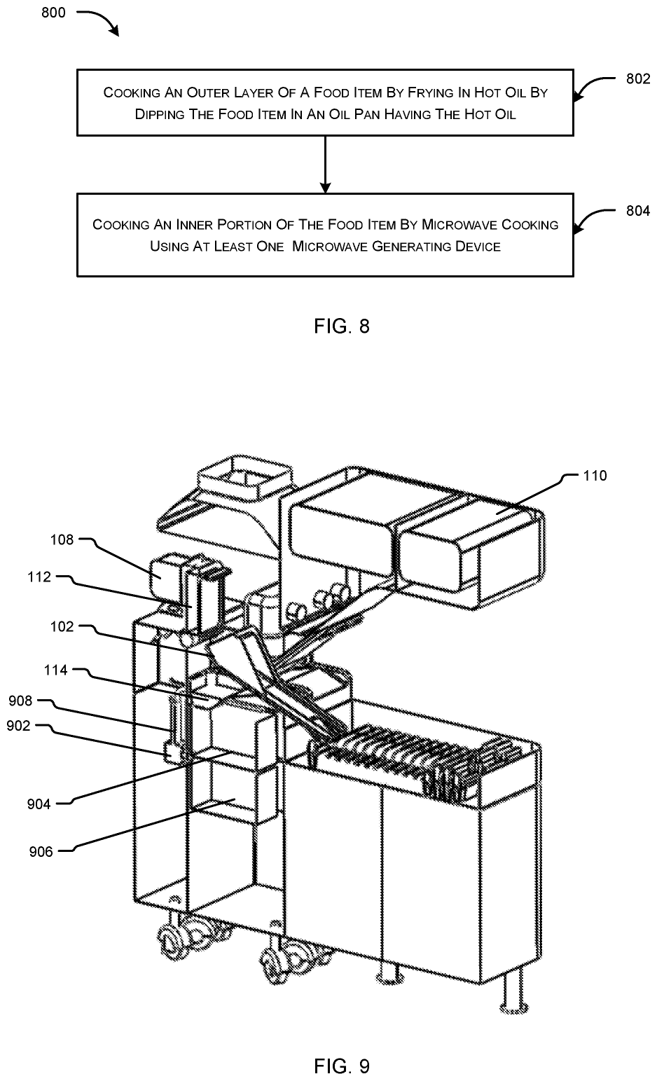

Referring to FIG. 9 where an exemplary perspective view of the disclosed frying apparatus is shown, the apparatus 100 can include a multi valve pump 902, a fresh oil storage tank 904 and a partially used oil storage tank 906. The fresh oil storage tank 904 and the partially used oil storage tank 906 may be coupled to the oil pan 114 through the multi valve pump 902 and a set of pipes 908 to transfer oil between the oil pan 114 and the fresh oil storage tank 904 and the partially used oil storage tank 906 depending on requirement as discussed earlier.

In an exemplary aspect, the proposed apparatus can further include an exhaust chimney.

In another aspect, while the serving portion 104 is connected to the cooking portion 106 on one side, on the other side, it opens into the food collection portion where the fried/microwaved food items are collected. The serving portion 104 or a part thereof can also be interchangeably referred to as food conveyer in the present disclosure.

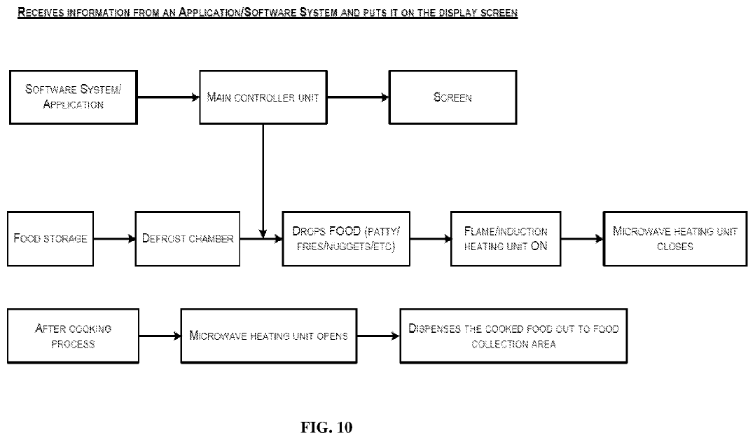

In an aspect, the apparatus 100 can include a controller to control various steps of the frying process. As shown in FIG. 10, the controller (also referred to as control unit or controller unit) may be operatively coupled to a mobile interface/application through which the frying process may be controlled. Alternatively, the apparatus 100 can be controlled using a user interface provided on the apparatus 100. The user interface can be through a screen (touch screen or button based, for instance) provided on the apparatus 100. As shown in FIG. 10, based on instructions provided to the controller (for instance, a main controller PCB), either by a communicatively coupled mobile/smartphone/computer/software application/app connected through a network, or through a screen based interface, the controller can move a selected food item from the storage station 110 to a defrost chamber, drop the food item on the loading and serving portion 104 of the pan 102, activate the conventional heat source, tilt the pan 102 to move the food item to the oil pan 114, and activate the microwave generating device 108 after closing the microwave generating device 108 over the pan 102. After the cooking duration, the controller can move the microwave generating device 108 away by opening it and move the pan 102 to move the fried food item to the loading and serving portion 104 of the pan 102. In an aspect, post cooking, the microwave unit 108 opens which in turn opens the food conveyer to slide cooked food into the food collection trays/bags, which triggers switch to add more food to cooking chamber from the top storage units. In an exemplary aspect, the proposed apparatus can further include a display to present instructions from the mobile application onto the said display, based on which the controller undertakes the cooking exercise. The proposed apparatus can further include/incorporate a microwave power supply.

In an exemplary aspect, instructions received from the mobile application and/or any other software system can include customer orders for the food/fried items such as order number, size of food item, extent of cooking/microwave required, status of order, among any other information pertaining to the manner in which the apparatus is to function/operate/work. The application can further mention the status of the oil, whether new/more oil is to be added, temperature conditions, used oil, absorbed oil, number of items processed in a given time duration, maintenance parameters, replenishment parameter of raw material for the food items, along with a number of analytics associated with the operation of the apparatus and ingredients that go into the same. All or any part of this information including reports, orders can also be presented on the display of the proposed apparatus.

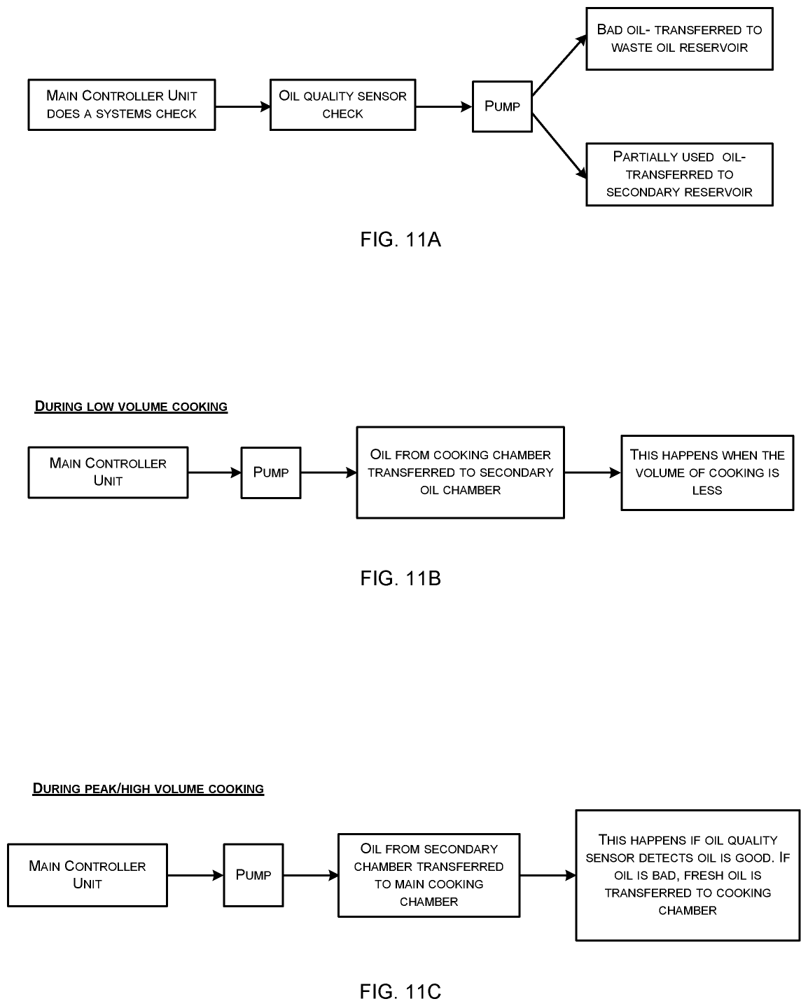

FIGS. 11A to 11C illustrate exemplary flow diagrams showing flow of oil between different tanks and the oil pan 114 during down time, low volume cooking, and peak/high volume cooking respectively, wherein, as shown in FIG. 11A, during downtime, the controller can check quality of oil in the oil pan 114 through an oil quality sensor, and if required, activate the multi valve pump 902 to transfer the oil, when the quality of oil is bad, to the waste oil tank. On the other hand, if the quality of oil is not bad, the controller can activate the multi valve pump 902 to transfer the oil to a secondary oil tank.

Likewise, as shown in FIGS. 11B and 11C, during low volume cooking and peak/high volume, the controller can actuate the multi valve pump 902 to transfer the oil between the oil pan 114 and the secondary oil reservoir, as required.

Thus, the present disclosure provides an improved frying apparatus that, by adding microwave cooking of interior of the food items, overcomes drawbacks of the conventional frying methods, results in reduction in frying time, reduces absorption of oil by the food item and reduced oil wastage.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE INVENTION

The present disclosure provides an improved frying apparatus that overcomes drawbacks of the conventional frying methods.

The present disclosure provides a frying apparatus that enables implementation of an improved frying method to overcome drawbacks of the conventional frying methods.

The present disclosure provides a frying apparatus that uses microwaves to enable direct cooking of interior of the food item as outer layer of the food item is being fried in hot oil.

The present disclosure provides a method of cooking using combination of microwave cooking and frying in combination.

The present disclosure provides a frying apparatus that has the ability to automatically load the food items into the frying pan from a frozen chamber.

The present disclosure provides a frying apparatus where the amount of oil can be reduced or increased depending upon the amount of food items to be fried automatically.

1. A frying apparatus for frying food items, the apparatus comprising:
an oil pan to hold oil for frying the food items;
a conventional heat source to heat the oil in the oil pan; and
at least one microwave generating device as a source of microwaves that in combination with application of heat using the conventional heat source enables direct cooking of interior of the food item as outer layer of the food item is being fried in the hot oil.

2. The apparatus as claimed in claim 1, wherein the conventional heat source is any or a combination of a gas burner, a hot plate, resistance heater and an induction heating device.

3. The apparatus as claimed in claim 1, wherein the apparatus comprises at least one pan, each pan comprising a loading and serving portion, and a cooking portion, the pan being pivotally held for movement between a first position and a second position, wherein, in the first position of the pan, the food items are loaded onto the loading and serving portion, and as the pan is moved to the second position, the food items slide to the cooking portion of the pan where the food items get dipped in hot oil for frying, and wherein when the pan is moved back to the first position from the second position, the food items slide back to the loading and serving portion for serving.

4. The apparatus as claimed in claim 3, wherein the apparatus includes a storage station comprising a plurality of frozen food chambers, one for each pan, and wherein each frozen food chamber includes a knob on the chamber to dispense the frozen food items into the pan, automatically or manually.

5. The apparatus as claimed in claim 3, wherein the apparatus includes a lid that is pivotally movable to cover the cooking portion in the second position of the pan.

6. The apparatus as claimed in claim 3, wherein the cooking portion includes strainer to drain the oil as the pan is moved from the second position to the first position.

7. The apparatus as claimed in claim 3, wherein the apparatus includes a housing, wherein a lower portion of the housing is configured to function as an oil pan to hold the oil, and the at least one microwave generating device is fixed to an upper portion of the housing.

8. The apparatus as claimed in claim 7, wherein the pan is pivotally configured with the housing such that in the second position of the pan the loading and serving portion of the pan closes an opening of the housing and the cooking portion of the pan dips into the oil held in the oil pan.

9. The apparatus as claimed in claim 3, wherein the cooking portion of the pan is configured to function as an oil pan to hold the oil and shaped such that the oil is retained within the cooking portion when the pan is at the second position.

10. The apparatus as claimed in claim 9, wherein at least one microwave generating device is operatively coupled to the pan to cover the cooking portion in the second position.

11. The apparatus as claimed in claim 9, wherein at least one microwave generating device is fixed, and the pan, when moved to the second position, gets coupled with the at least one microwave generating device.

12. The apparatus as claimed in claim 1, wherein the apparatus comprises an oil transfer mechanism comprising an oil storage tank and an oil transfer pump.

13. The apparatus as claimed in claim 12, wherein the oil transfer mechanism is configured to transfer oil between the oil pan and the oil storage tank based on quantity of the food items to be fried.

14. The apparatus as claimed in claim 12, wherein the oil transfer mechanism is configured to, when there is no requirement of frying, transfer the oil from the oil pan to the oil storage tank to minimize the oil quantity in the oil pan that is kept in hot condition to meet frying requirement within a stipulated time frame on receipt of order.

15. The apparatus as claimed in claim 1, wherein the apparatus comprises a controller configured to receive instructions based on which operation of the frying apparatus is controlled.

16. The apparatus as claimed in claim 15, wherein the controller receives said instructions from a mobile application/system such that upon receipt of said instructions, the controller moves a selected food item from a storage station onto a loading and serving portion of a pan, activates the conventional heat source by tilt the pan to move the food item to an oil pan, and activates the microwave generating device after closing the microwave generating device over the pan.

17. The apparatus as claimed in claim 16, wherein after the cooking, the controller moves the microwave generating device away by opening it and move the pan to move the fried food item to the loading and serving portion of the pan.

18. A method for cooking a food item comprising the steps of:
cooking an outer layer of the food item by frying in hot oil by dipping the food item in an oil pan having the hot oil; and
cooking an inner portion of the food item by microwave cooking using at least one microwave generating device; wherein the food item is placed on a pan that is configured to move between a first position and a second position, and the frying takes place in the second position of the pan and the microwave cooking takes place in the second position of the pan.
